(19) United States
(12) Patent Application Publication
(10) Pub. No.: US 2007/0027938 A1
(43) Pub. Date: Feb. 1, 2007

(54) Detecting data changes

(75) Inventor: James Clarke, Bedford, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Scribe Software Inc., Bedford, NH (US)

(21) Appl. No.: 11/491,866

(22) Filed: Jul. 24, 2006

Related U.S. Application Data
(60) Provisional application No. 60/702,527, filed on Jul. 26, 2005.

(51) Int. Cl. G06F 17/30

(52) U.S. Cl. 707/204

(57) ABSTRACT

The present invention provides a device, method, and system for efficiently converting data into a common format, detecting changes, and updating a stored copy of data with the detected changes. The system walks through a snapshot set of data and a source set and data and compares key values and associated stored data. The system may detect rows that have modified data but have not been added or deleted. The system may detect a new or a deleted record or data source rows by examining the key values of the snapshot data record and the key values of the source data record.

### CROSS-REFERENCE TO RELATED APPLICATIONS

The present application claims priority from U.S. provisional patent application Ser. No. US60/702,527, filed Jul. 26, 2005, by James Clarke, incorporated by reference herein and for which benefit of the priority date is hereby claimed.

### TECHNICAL FIELD

The present invention relates to detecting data changes and more particularly, relates to detecting changes of data and may be used to provide an updated set of data for other applications.

### BACKGROUND INFORMATION

Data storage and retrieval systems are often responsible for maintaining an updated source of data. The system must keep a stored copy of data and update the stored copy of data with edited versions of the data. As the system receives an edited version of data, the system compares the edited copy with the currently stored copy of data. The stored copy of data is then updated with the detected changes. The edited version may be a copy supplied by a user or other platform that may add, delete, or modify the data.

The edited copy of data or source data may be in a variety of formats. The data storage and retrieval system may need to keep track of the type of data stored and identify the types of data received that the system is to add, delete, or modify the data stored. To accomplish this, the system often converts the data into a common format that allows the system to extract the edited data and compare the data with the stored data in an efficient manner.

The system may need to receive large volumes of edited data from a variety of platforms and maintain a current version of data that incorporates the edited data while minimizing the use of processing resources of the system and prevent peak demand surges. The system may also need to notify other platforms or application of detected changes. Accordingly, a need exists for a device, method, and system for efficiently converting data into a common format, detecting changes, and updating a stored copy of data with the detected changes.

### BRIEF DESCRIPTION OF THE DRAWINGS

These and other features and advantages of the present invention will be better understood by reading the following detailed description, taken together with the drawings wherein:

FIG. 1 is an exemplary representation of a copy of source data and a copy of snapshot data for illustrating the device, method, and system, according to the present invention.

FIG. 2 is a system diagram of an exemplary data storage and retrieval system used to detect changes and publish a queue of changes to the data, according to the present invention.

FIG. 3 is a flow chart illustrating an exemplary embodiment of a method for converting source data into a common format, detecting changes, updating a snapshot copy of data with the detected changes, and publishing a queue of changes, according to the present invention.

FIG. 4 is continuation of the flow chart in FIG. 3 illustrating the exemplary embodiment of the method for converting source data into a common format, detecting changes, updating a snapshot copy of data with the detected changes, and publishing a queue of changes, according to the present invention.

### DETAILED DESCRIPTION

The present invention provides a device, method, and system for efficiently converting data into a common format, detecting changes, and updating a stored copy of data with the detected changes. The exemplary method also notifies other applications of the detected changes. The exemplary method determines changes, for example, new, modified, or deleted data of a data source. The data source may be ordered in a consistent manner using, for example, a key field. The selected key field(s) must be unique within the data set and unmodifiable. The data source is compared to a prior snapshot of the data. The snapshot of data is the previously current version of the data stored by the system. The snapshot of data may be saved as XML messages within a database table. Data is queried from the snapshot database where the label identifies the correct subset. The results are ordered to match the order of the data source. The system walks through both sets of data in parallel by sequentially walking through the ordered data sets and comparing key values and associated stored data.

The system may be efficient in that it only requires two queries (the source and the snapshot) and one walk-through from the first record to the last record on both queries. The combination of a data set label and the XML body allows one database table to contain snapshots for many sources. This may provide a simpler setup and management of snapshot data. The system allows one database table to contain snapshot data from many different sources of various structures.

The walk-through allows the system to detect unmodified rows that have matching keys and data that remain unchanged. The system may detect rows that have modified data but have not been added or deleted. The system may detect a new record or data source rows by identifying a data source row without a matching snapshot row where the data source key value is less than the snapshot key value. Similarly, the system also may detect a deleted record or data source rows by identifying a snapshot row without a matching data source row where the snapshot key value is less than the data source key value. Once the system detects new, modified, or deleted data the system may create an XML (Extensible Markup Language) message to update the snapshot data with the new, modified, or deleted data.

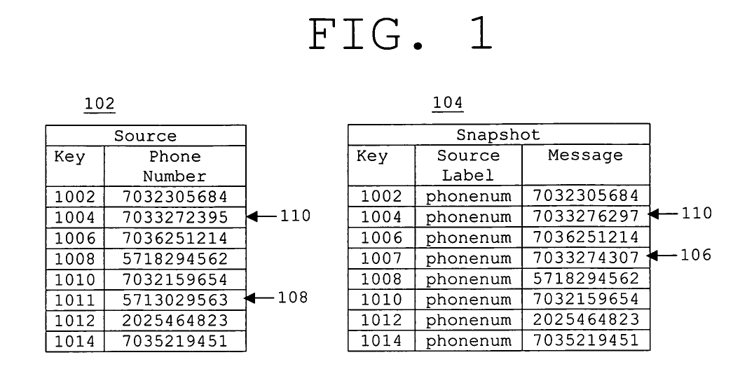

An exemplary representation of a copy of source data 102 and a copy of snapshot data 104 is shown in FIG. 1. The snapshot data 104 may have a key, a source label, and a message for each row. The snapshot data 104 may be in XML format. XML format provides a flexible way to create common information formats and share both the format and the data. The invention is not limited to XML data format; other methods and data protocols may be used to implement the present invention. Accordingly, the representative copy of snapshot data, shown in FIG. 1, has multiple rows or records of data. Each row, for example the first row, has a key “1002”, a source label “phonenum”, and a message “7032305684”. The key identifies the row or set of data. The key field may store key sequential values or use a variety of other methods to track and maintain the order of records. The key may not be limited to one field. The key may be a combination of fields. For example, a user may select multiple fields to represent the key that uniquely represent the row of data. The source label identifies the type of data. In the exemplary first row of the snapshot data 104 shown in FIG. 1, the message stored is a phone number “703-230-5684” and identified with the source label “phonenum”. The snapshot data might also contain other “housekeeping” columns or elements, for example, the last date the row or record was modified.

The source data 102 may be received by the system in XML format or other predefined tabular format such as that returned by a relational database query. If the source data 102 is not in the predefined format, the system may convert each row or set of source data 102 into the predefined format. This may be done as each row or record is compared to the respective snapshot row or record. The routine converting of each row or record as the system compares each row or record of the source data with the snapshot data allows the processor to systematically convert the source data without requiring the conversion of the entire data source at once and overloading the processing capability.

In the exemplary representation of a copy of source data 102 and snapshot data 104, a deleted row 106 is present in the snapshot data 104 and not in the source data 102. Similarly, a new row 108 is present in the source data 102 and not in the snapshot row 104. A modified row 110 is present in both source data 102 and snapshot data 104. The modified row 110 has the same key, however, the data of the row has been modified. The system may be used to detect new rows 108, deleted rows 106 and modified rows 110, as will be discussed later herein.

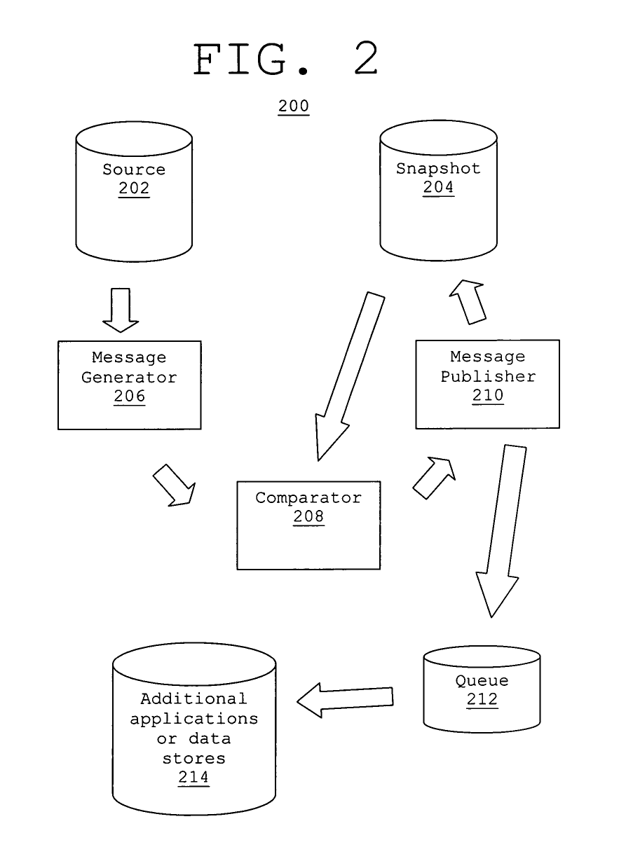

FIG. 2 is a system diagram of an exemplary data storage and retrieval system 200 used to detect changes and maintain an updated copy of the data, according to the present invention. The source data 102 may be stored in a source database 202. The snapshot data 104 may be stored in a snapshot database 204. For illustrative purposes the source database 202 and snapshot database 204 are shown as being separate databases, however, it should be apparent that the data may be stored in separate tables or views within a single database or within other types of data sources.

A message generator 206 may be used to convert a row of data into XML format. The message generator 206 produces a message containing all the data values for a given source row. The message can be in XML format, or another stream format suitable to performance and storage requirements. The message generation provides a set of individual data column values for a given row and is serialized into a single data stream. The data stream may then be efficiently stored, retrieved, and compared using the consistent mechanism regardless of the nature of the individual source columns.

A comparator 208 determines if the row or record of data has been added, deleted, or modified. The comparator 208 determines if the key of the source set matches the key for the snapshot set. If the key matches, the comparator 208 examines the message data of the snapshot set with the message data of the source set. If the messages match, the message has not been modified and examination of the record is complete. If the messages do not match, the message publisher 210 updates the snapshot database 204 with the message in the source record. The message publisher also outputs the message to a queue or change log 212. The queue 212 may be accessed by additional applications 214 to provide notice of the detected changes.

If the key of the source set does not match the key of the snapshot set, the key of the source set is examined to determine if the key is greater than or less than the key of the snapshot set. If the data source key value is less than the snapshot key value, a new record is identified. The message publisher 210 updates the snapshot database with the new record. If the data source key value is greater than the snapshot key value, a deleted record is identified. The message publisher 210 deletes the record from the snapshot database.

The current source data is periodically compared to the contents of the snapshot table to determine which source records are new, which have been modified, and which have been deleted since the last time such a comparison was performed. A query is performed against the data source, returning the current set of source records ordered by the key. A query is performed against the snapshot database, returning the last set of snapshot records for the data source identified by source label. These records are also ordered by key. A current row position is maintained in the source data results. This row may be referred to as the “current source row”. A current row position is maintained in the snapshot results. This row may be referred to as the “current snapshot row”. If no rows are returned by a query, or the current position moves past the last row, that row is referred to as “EOF”. For both queries, the current row is initialized to the first row of the returned results, or to EOF if no rows were returned.

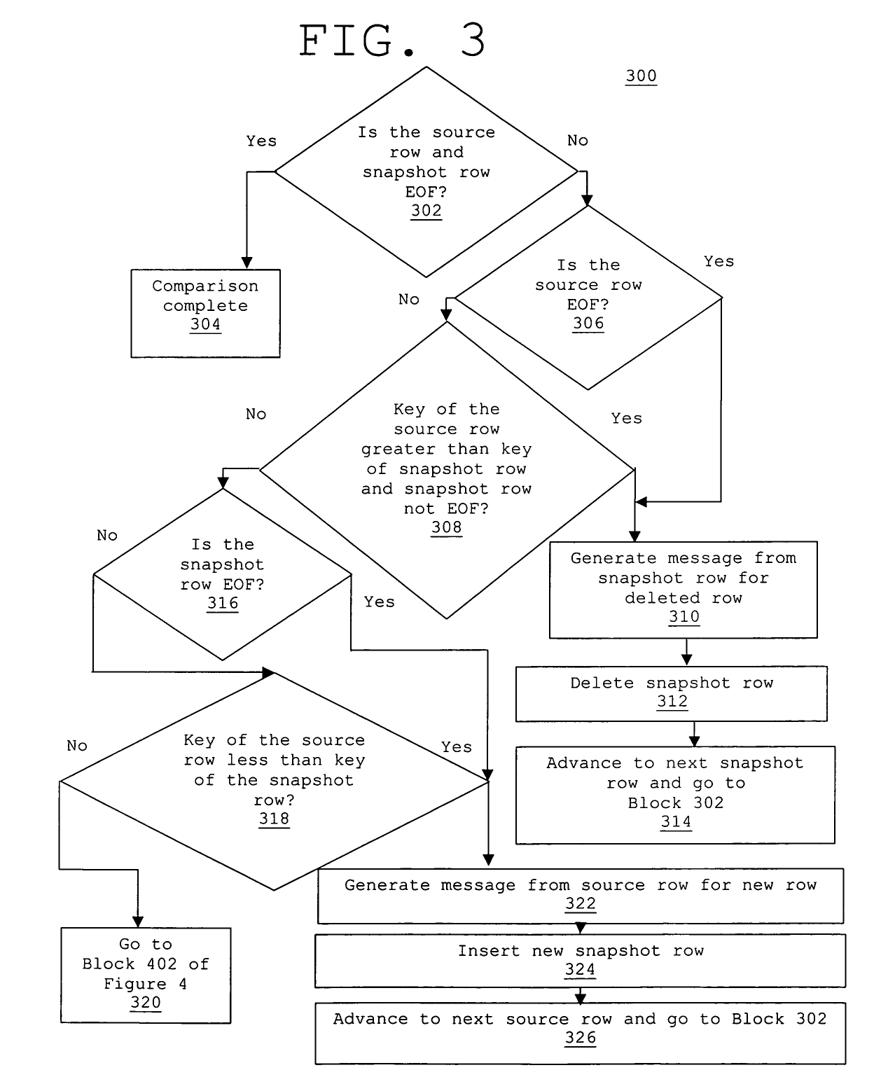

FIG. 3 is a flow chart illustrating an exemplary embodiment of a method for converting source data into a common format, detecting changes, and updating a snapshot copy of data with the detected changes 300, according to the present invention. The method determines if the current source row and current snapshot row are EOF (Block 302). If both the current source row and current snapshot row are EOF (“yes” branch of block 302), the comparison is complete (block 304) and the method waits to be initiated. Initiation of the method may be triggered by a variety of events or commands. For example, the method may be triggered periodically to maintain an updated snapshot or an event may be used to trigger the method.

If one of the current source rows or current snapshot rows is not EOF (“no” branch of block 302), the method may determine if the source row is EOF (block 306). If the current source row is EOF (“yes” branch of block 306), the method has detected a deleted row and proceeds to block 310 as will be discussed later herein. If the current source row is not EOF (“no” branch of block 306), the method determines if the key of the source row is sequentially greater than the key of the snapshot row and the snapshot row is not EOF (block 308). If the key of the source row is sequentially greater than the key of the snapshot row and the snapshot row is not EOF (“yes” branch of block 308), the method has detected a deleted row. The method generates a message for the deleted row (block 310). The row is deleted from the snapshot database (block 312). The method advances to the next snapshot row and cycles to the beginning of the method and proceeds with the detection of changes for the next row or entry of data (block 314).

If the key of the source row is not sequentially greater than the key of the snapshot row or the snapshot row is EOF (“no” branch of block 308), the method determines if the current snapshot row is EOF (block 316). If the current snapshot row is EOF (“yes” branch of block 316), the method has detected a new row and proceeds to block 322 as will be discussed later herein. If the current snapshot row is not EOF (“no” branch of block 316), the method determines if the key of the source row is sequentially less than the key of the snapshot row (block 318). If the key of the source row is sequentially less than the key of the snapshot row (“yes” branch of block 318), the method has detected a new row. The method generates a message for the new row (block 322). The message may be in XML format and include the data associated with the new row. The data is inserted into the snapshot database with the data of the message (block 324). The method advances to the next source row and cycles to the beginning of the method and proceeds with the detection of changes for the next row of data (block 326).

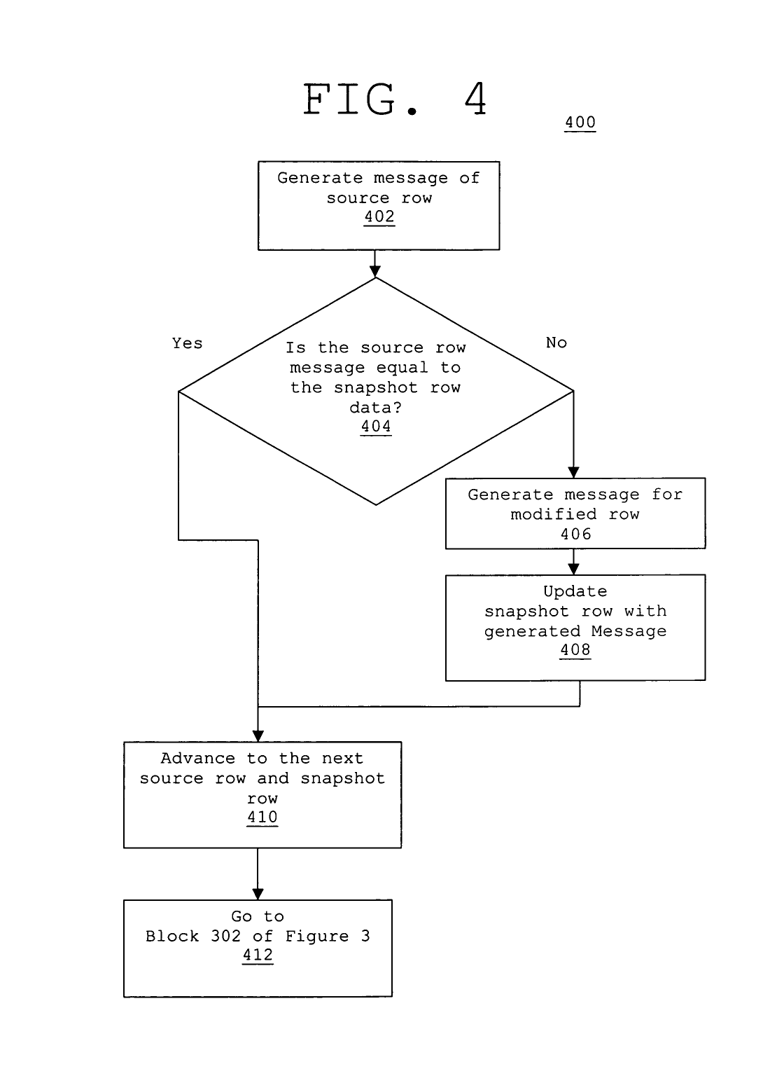

If the key of the source row is not sequentially less than the key of the snapshot row (“no” branch of block 318), the method proceeds to block 402 of FIG. 4 (block 320). At this point the key values have been determined equal. The method generates a message of the source row (block 402). The method determines if the source row message is equivalent to the snapshot row data (block 404). If the source row message is not equivalent to the snapshot row data (“No” branch of block 404), the method has detected a change in data for the current snapshot row. The method may generate and send the message of the source row (block 406). The method updates the snapshot database with the data in the generated message (block 408). If the method detects no change between the source row message and the snapshot row data (“Yes” branch of block 404) or the method has updated the snapshot database with the new data, the method advances to the next source row and snapshot row (block 410). The method cycles to the beginning of the method (block 302) and proceeds with the detection of changes for the next row or enter of data (block 326). The method continues to cycle through until all rows have been examined for the source data and snapshot data.

Modifications and substitutions by one of ordinary skill in the art are considered to be within the scope of the present invention, which is not to be limited except by the following claims.

The invention claimed is:

1. A method for detecting changes in data comprising the action of:
receiving the data source with data source rows each with one or more key fields and one or more data fields and a snapshot with snapshot rows each with a key field and message field;
comparing sequentially a key of the key fields of a data source row with a corresponding sequential key of the key field of snapshot row;
when the key of the data source row is greater than the key of the snapshot row, deleting the snapshot row; and
when the key of the data source row is less than the key of the snapshot row, adding a snapshot row and generating message data from the data fields of the data source row to the message field of the added snapshot row.

2. A method for detecting changes in data of claim 1 further comprising the action of:
when the key of the data source row matches the key of the snapshot row, comparing a message of the message field of the snapshot row to a generated message of the data fields of the data source row;
and when the message of the message field of the snapshot row does not match the generated message of the data fields of the data source row copying generated message data from the data fields of the data source row to the message field of the snapshot row.

3. A method for detecting changes in data of claim 1 wherein the key of the data source and the key of the snapshot are unique for each row and unmodifiable

4. A method for detecting changes in data of claim 1 wherein the snapshot data is stored as XML messages within a database table.

5. A method for detecting changes in data of claim 1 wherein the method compares sequentially each key of the data source rows with the key of the corresponding snapshot row in parallel by sequentially walking through and comparing key values of each row of the data source and snapshot.

6. A method for detecting changes in data of claim 1, when an end of the data source is detected and the end of the snapshot is not detected, deleting a current snapshot row.

7. A method for detecting changes in data of claim 1, when an end of the snapshot is detected and the end of the data source is not detected, adding a snapshot row and copying generated message data from the data source row to the added snapshot row.

8. A system for detecting changes in data comprising:
a data source with one or more records each having one or more key fields and one or more data fields;
a snapshot database with one or more records each having a key field and message field;
a comparator for comparing sequentially each key in the key fields of a data source row with a parallel, corresponding key in the key field of a snapshot row;
a message publisher that deletes the snapshot record when the key of the data source record is greater than the key of the snapshot record; and generates a new snapshot record and a copy of the message data generated of the data fields of the data source record to add to the message field of the new snapshot record when the key of the data source record is less than the key of the snapshot record.

9. A system for detecting changes in data of claim 8 wherein:
the comparator compares a message in the message field of the snapshot record to a generated message from the data fields of the data source record when the key of the data source record matches the key of the snapshot record; and
the message publisher enters the message data into the corresponding message field of the snapshot record when the message in the generated message of the data source record does not match the message in the message field of the snapshot record.

10. A system for detecting changes in data of claim 8 wherein the key fields are unique within each data set and unmodifiable

11. A system for detecting changes in data of claim 8 wherein the snapshot data is stored as XML messages within a database table.

12. A system for detecting changes in data of claim 8 wherein the comparator compares sequentially each key of the data source records with the key of the corresponding snapshot record in parallel by sequentially walking through and comparing key values of each record of the data source and snapshot.

13. A system for detecting changes in data of claim 8, wherein the message publisher deletes the snapshot record when the comparator detects an end of the data source and an end of the snapshot is not detected.

14. A system for detecting changes in data of claim 8, wherein the message publisher adds a snapshot record and copies message data generated from the data source record to the message of the added snapshot record when the comparator detects an end of the snapshot rows and not an end of the data source rows.

15. A system for detecting changes in data of claim 8, further comprising a queue log for recording actions of the message publisher.

16. A computer program product, tangibly embodied in an information carrier, for detecting changes in data, the computer program product being operable to cause a machine to:
receiving the data source with data source rows each with one or more key fields and one or more data fields and a snapshot with snapshot rows each with a key field and message field;
comparing sequentially a key of the key fields of a data source row with a corresponding sequential key of the key field of snapshot row;
when the key of the data source row is greater than the key of the snapshot row, deleting the snapshot row; and
when the key of the data source row is less than the key of the snapshot row, adding a snapshot row and generating message data from the data fields of the data source row to the message field of the added snapshot row.

17. The computer program product of claim 16, further comprises the computer program product being operable to cause the machine to:
when the key of the data source row matches the key of the snapshot row, comparing a message of the message field of the snapshot row to a generated message of the data fields of the data source row;
and when the message of the message field of the snapshot row does not match the generated message of the data fields of the data source row copying generated message data from the data fields of the data source row to the message field of the snapshot row.

18. The computer program product of claim 16, wherein the snapshot data is stored as XML messages within a database table.

19. The computer program product of claim 16, further comprises the computer program product being operable to cause the machine to:
when an end of the data source is detected and the end of the snapshot is not detected, deleting a current snapshot row.

20. The computer program product of claim 16, further comprises the computer program product being operable to cause the machine to:
when an end of the snapshot is detected and the end of the data source is not detected, adding a snapshot row and copying generated message data from the data source row to the added snapshot row.
